(19) United States
(12) Patent Application Publication
(10) Pub. No.: US 2024/0416222 A1
(43) Pub. Date: Dec. 19, 2024

(54) GAME SYSTEM AND ITEM ACQUISITION GAME DEVICE

(71) Applicant: SEGA CORPORATION, Tokyo (JP)

(72) Inventors: Taro Tamukai, Tokyo (JP); Norihiro Saito, Tokyo (JP); Nobuyuki Takano, Tokyo (JP); Mitsuharu Fukazawa, Tokyo (JP); Takaya Goshozono, Tokyo (JP); Yusuke Orima, Tokyo (JP); Masaya Nakano, Tokyo (JP); Shuhei Nakayama, Tokyo (JP)

(73) Assignee: SEGA CORPORATION, Tokyo (JP)

(21) Appl. No.: 18/816,854

(22) Filed: Aug. 27, 2024

Related U.S. Application Data
(63) Continuation of application No. PCT/JP2023/006322, filed on Feb. 21, 2023.

(30) Foreign Application Priority Data
Feb. 28, 2022 (JP) 2022-029879

(51) Int. Cl. A63F 9/30; G07F 11/16

(52) U.S. Cl. CPC A63F 9/30; G07F 11/165

(57) ABSTRACT

A game system includes item acquisition game devices and a server. Each item acquisition game device includes: a game field that is disposed in a play space and has a first area and a second area; an item holder that holds the items; an operation device that receives operations from a player, and a data processing device that gives credits depending on a play fee, drives the item holder in response to the operations on condition that credits have been used, and determines whether the items have been moved to the second area. The server includes a data processing device that converts credits that are unused in a first item acquisition game device into credits for a second item acquisition game device, after receiving a transfer instruction for credits given in the first item acquisition game device from the player.

### BACKGROUND

### Technical Field

The present invention relates to an item acquisition game in which prizes or other such items are acquired.

### Description of Related Art

Many amusement arcades include claw crane devices (item acquisition game devices). A stage (game field) is provided inside the housing of the claw crane device, and prizes (items) such as stuffed toys or candy are placed on this stage. The player uses horizontal and vertical buttons, etc. to operate an item holder such as a crane. If the player can grab a prize with the crane and move it to the drop opening, the player wins that prize.

Before playing, a player obtains credits by paying a play fee. These credits can be used to play the claw crane, and when a player has three credits, three attempts can be made in the claw crane. Since prizes in claw crane devices are not easy to acquire, several credits worth of play fees are often paid for as a lump sum (see Patent Literature 1).

### PATENT LITERATURE

Patent Literature 1: Japanese Patent No. 6844586

### Technological Problem to be Solved by the Invention

If a player buys a number of credits, some of the credits may remain unused after the player has won the prize they were aiming for. The store wants the player to continue playing the claw crane and use up these unused credits, but once the player has achieved the objective, the player may not feel like continuing to play anymore. In this situation, there currently are not any specific means for making use of unused credits with a specific algorithm in a game system installed in the amusement arcade.

### SUMMARY

The present invention was conceived in view of the above technological problem, and provides a technique for effectively utilizing unused credits in an item acquisition game device with a specific algorithm.

The game system according to one aspect of the present invention comprises a plurality of item acquisition game devices and a server.

The item acquisition game devices include a game field that is disposed in a play space and has a first area and a second area, wherein items to be acquired are placed in the first area and moved to the second area; an item holder that holds one or more of the items; an operation device that receives operations from a player; a data processing device that: gives credits depending on a play fee paid by the player; drives the item holder in response to the operations on condition that credits have been used; and determines whether one or more of the items have been successfully moved to the second area.

The item acquisition game devices include a first item acquisition game device, and a second item acquisition game device that serves as a transfer destination.

The server comprises a data processing device that converts credits that are unused in the first item acquisition game device into credits for the second item acquisition game device, after receiving a transfer instruction for credits given in the first item acquisition game device from the player.

The item acquisition game device according to one aspect of the present invention comprises a game field that is disposed in a play space and has a first area and a second area, wherein items to be acquired are placed in the first area and moved to the second area; an item holder that holds one or more of the items; an operation device that receives operations from a player; a data processing device that: gives credits depending on a play fee paid by the player; drives the item holder in response to the operations on condition that credits have been used; and determines whether one or more of the items have been successfully moved to the second area.

The data processing device outputs, to an external device, information on at least one of unused credits and the play fee corresponding to the unused credits, in response to a credit transfer instruction received from the player.

The game system according to another aspect of the present invention comprises a plurality of game devices, a communication terminal, and a server.

A game machine ID for identifying each of the game devices is registered in each of the game devices, and a player ID for identifying the player is registered in the communication terminal.

Each of the game devices comprises a data processing device that: gives credits depending on a play fee paid by a player, and controls a game progress on condition that credits have been used.

A first device that is either the game devices or the communication terminal acquires the player ID or the game machine ID registered in a second device that is either the communication terminal or the game devices, and transmits, to the server, the game machine ID or the player ID registered in the first device and the player ID or the game machine ID acquired from the second device.

The server comprises a data processing device that registers, as a pair, the player ID and the game machine ID associated with each other, and converts unused credits that are unused in the first game device into credits for the second game device in response to an instruction to transfer the unused credits received from a player registered as a pair with the first game device.

With the aspects of the present invention, it becomes possible to effectively utilize the unused credits in the item acquisition game device with a specific algorithm.

### BRIEF DESCRIPTION OF THE DRAWINGS

FIG. 1 is a hardware configuration diagram of a game system;

FIG. 2 is a schematic diagram of the overall configuration of a claw crane device;

FIG. 3 is a functional block diagram of a server;

FIG. 4 is a functional block diagram of the claw crane device;

FIG. 5 is a diagram showing an initial screen;

FIG. 6 is a sequence diagram showing the steps of pairing processing;

FIG. 7 is a data structure diagram of pairing information;

FIG. 8 is a diagram of an occupancy screen;

FIG. 9 is a sequence diagram showing the steps of occupancy processing;

FIG. 10 is a diagram of a screen on which occupancy can be cancelled;

FIG. 11 is a diagram of a transfer screen;

FIG. 12 is a diagram showing the data structure of credit management information; and

FIG. 13 is a sequence diagram showing the steps of transfer processing.

### DETAILED DESCRIPTION

In the following, the configuration and basic functions of a claw crane device as an example of an item acquisition game device will first be described. Next, the three functions of the claw crane device in one or more embodiments, namely, the “pairing function,” the “occupancy function,” and the “transfer function,” will be described in that order. The “item holder” is not limited to being a type that is suspended from above as in a crane, and may instead be a type that hooks or pushes in prizes from the side, but in the following embodiments a crane shall be used as an example.

The pairing function is a function for associating the claw crane device with a player, and is basically similar to a login, and will be described in detail below. The occupancy function is a function for enabling a player to occupy the claw crane device for a while even if the player leaves the claw crane device for a short period. The transfer function is a function for transferring remaining credits that are unused in one claw crane device to another claw crane device.

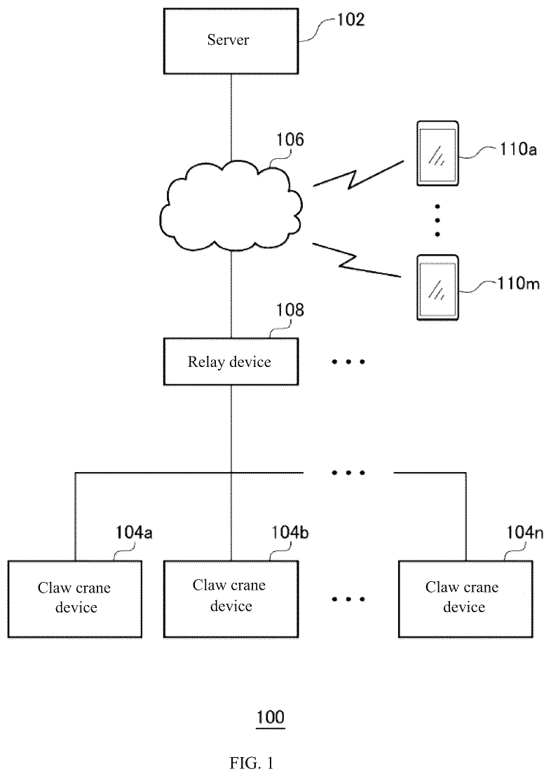

FIG. 1 is a diagram of the hardware configuration of a game system 100.

In the game system 100, a plurality of claw crane devices 104a, 104b, . . . , 104n (hereinafter, when referred to collectively or when no distinction is made between them, these will be referred to as the “claw crane device 104”) and user terminals 110a, . . . , 110m (hereinafter, when referred to collectively or when no distinction is made between them, these will be referred to as the “user terminal 110”) are connected to a server 102 via the Internet 106.

The claw crane device 104 is connected to the server 102 via a relay device 108. A relay device 108 is installed for each store or for each floor of a store, and is connected to one or more claw crane devices 104.

The user terminal 110 (communication terminal) in one or more embodiments shall be assumed to be a smartphone. The user terminal 110 may be a tablet terminal or a laptop PC. The user terminal 110 and the Internet 106 are connected wirelessly, but may also be connected by wire. A dedicated application (hereinafter called “CS (crane service) software”) is installed on the user terminal 110.

The claw crane devices 104 are installed in an amusement facility such as an amusement park or an amusement arcade. In order to control the claw crane devices 104 remotely, a tablet terminal used by an operator who operates the amusement facility may be connected to each claw crane device 104.

The server 102 provides various services for the claw cranes, such as the pairing function, occupancy function, and transfer function mentioned above. The player downloads the CS software from the server 102 to the user terminal 110. At this point, player registration is carried out, and the server 102 assigns a player ID to the player. The player ID is also registered in the user terminal 110. The server 102 also registers a game machine ID for identifying the claw crane device 104, and a store ID for identifying the store in which the claw crane device 104 is installed.

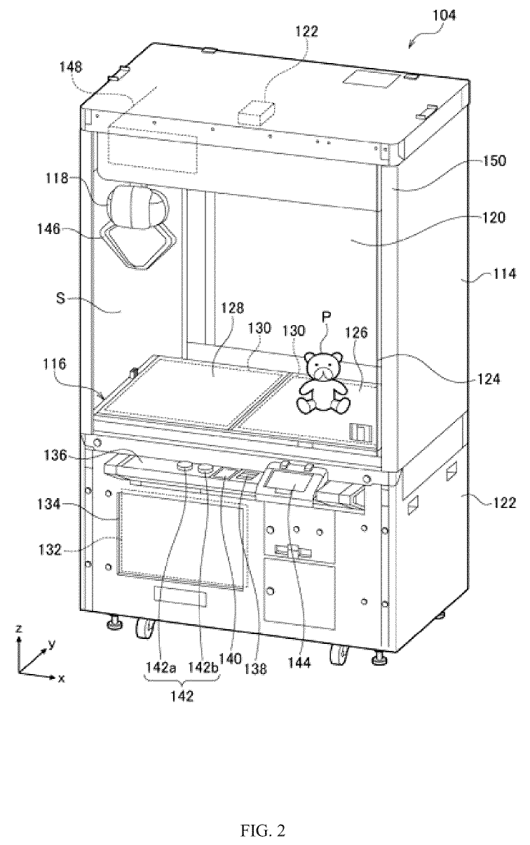

FIG. 2 is a schematic diagram of the overall configuration of the claw crane device 104.

The claw crane device 104 comprises a rectangular cuboid base 112 and a box-shaped prize holder 114 provided on top of the base 112. A play space S is formed inside the prize holder 114, and a prize placement platform 116 (game field) is provided. Prizes P such as stuffed toys or trinkets are placed on the prize placement platform 116. A crane 118 is provided above the prize placement platform 116. The crane 118 can move back and forth, left and right, and up and down in the play space S to grasp or release a prize P.

The front side and the left and right sides of the prize holder 114 are made of transparent glass. This allows the prizes P to be seen from the outside. A monitor 120 is provided on the rear surface (back side) of the prize holder 114. The monitor 120 displays various kinds of presented images. A camera 122 is installed on the ceiling of the claw crane device 104. The camera 122 captures an image of the prize placement platform 116 from above. The monitor 120 can also display images captured by the camera 122.

An LED (light emitting diode) is provided on a post 150 of the claw crane device 104 and lights up as part of the presentation during play. A door 124 is provided on the front of the prize holder 114, allowing an operator to place prizes P inside the prize holder 114.

The prize placement platform 116 is partitioned into a first area 126 and a second area 128. Each of these partitioned areas is constituted by a removable panel. When either of the panels is removed, this forms a drop opening 130 through which a prize P can be dropped. When a prize P is placed in the first area 126 and a drop opening 130 is formed in the second area 128, the player can acquire the prize P if they are able to move the prize P from the first area 126 to the second area 128 (drop opening 130).

Inside the base 112, a prize stock space 132 is formed to store the prizes P that have dropped through the drop opening 130. A prize removal opening 134 is formed in the front surface of the base 112 to allow the prizes P that have dropped into the prize stock space 132 to be taken out.

An operation console 136 is provided on the front side of the base 112. The operation console 136 is provided with a coin slot 138, an IC (integrated circuit) card reader 140, an operation device 142, and a setting display 144. To start a game, a player inserts a coin into the coin slot 138 or touches the IC card reader 140 with an IC card loaded with electronic money. In the latter case, payment processing is carried out using electronic money, but since this is known technology, it will not be described in detail herein.

The operation device 142 has operation buttons 142a and 142b that allow the player to move the crane 118. The operation device 142 functions as a “crane operation unit” that receives input signals based on player operations. The operation button 142a is used for moving the crane 118 in the left and right direction (X direction), and the operation button 142b is used for moving the crane 118 in the forward and backward direction (Y direction). Alternatively, the crane 118 may be moved forward, backward, left, and right with a joystick.

The setting display 144 is provided with a touch panel. The setting display 144 receives the input of game setting information from the operator and displays information related to the game, such as how to operate the operation device 142 or the game results. The claw crane device 104 also comprises a speaker (not shown), an external connection terminal, and the like.

The crane 118 has arms 146 capable of grasping and releasing prizes P. The crane 118 includes a motor that drives the opening and closing of the arms 146. A prize P is grasped or released by opening or closing the arms 146.

The crane 118 can move along a guide rail (not shown) installed on the upper part of the prize holder 114 and is driven by a crane driver 148. The crane driver 148 includes a moving mechanism that drives the crane 118 in the side-to-side direction (X direction) and the back-and-forth direction (Y direction) and a lifting and lowering mechanism that drives in the up- and down-direction (Z direction). The moving mechanism includes an X direction motor and a Y direction motor. The lifting and lowering mechanism includes a Z direction motor. The crane driver 148 can move the crane 118 to any position in the play space S. Since a driver mechanism such as this is well known, it will not be described in detail herein.

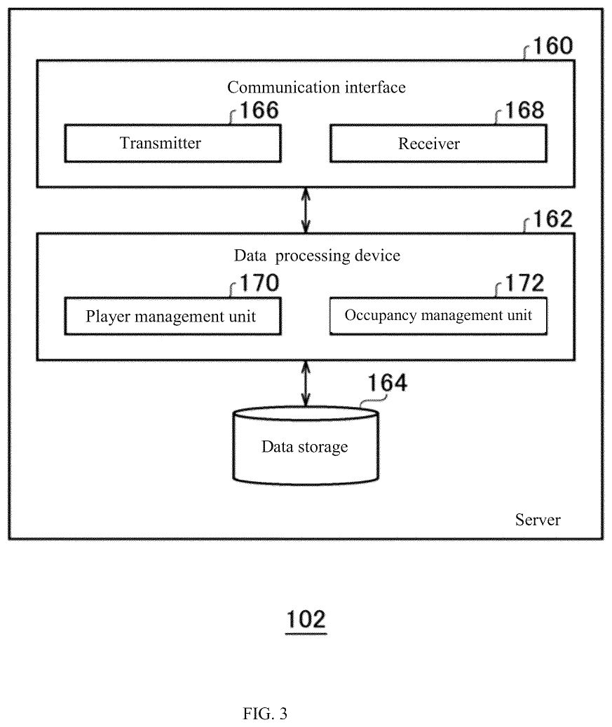

FIG. 3 is a functional block diagram of the server 102.

The constituent elements of the server 102 are realized by hardware including computing units such as a CPU (central processing unit) and various coprocessors, storage devices such as memory and storage, and wired or wireless communication lines connecting these, as well as software that is stored in the storage devices and supplies processing instructions to the computing units. A computer instruction or a computer program may be constituted by a device driver, an operating system, various application instructions or programs located at higher layers than these, and a library that provides common functions to these instructions or programs. The blocks described below indicate blocks of functional units, rather than the configuration of hardware units.

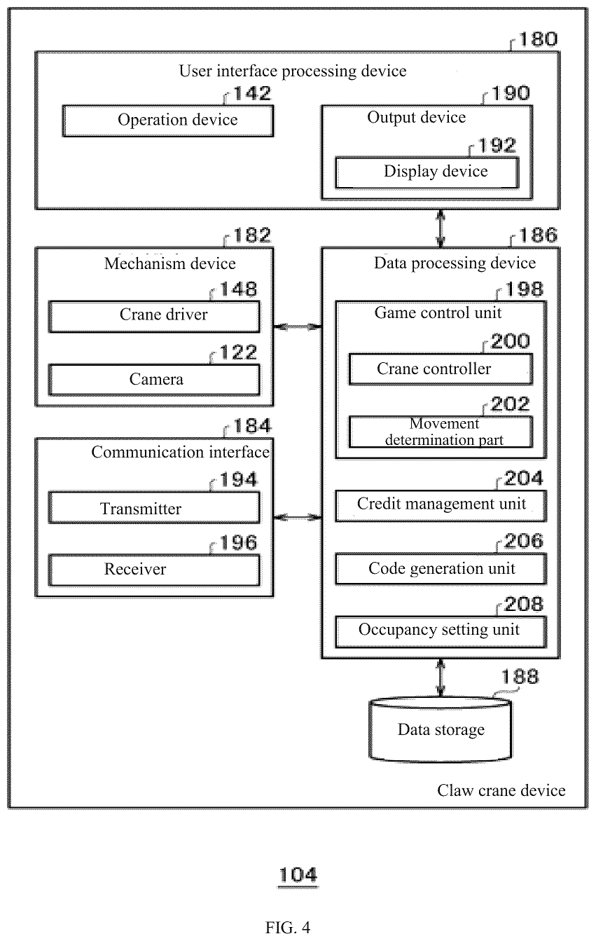

The same applies to the constituent elements of the claw crane device 104 that will be described next in reference to FIG. 4.

The server 102 includes a data processing device 162, a data storage 164, and a communication interface 160.

The communication interface 160 handles communication processing between the user terminal 110 and the relay device 108. The data storage 164 stores various kinds of data. The data processing device 162 may comprise a CPU (central processing unit) and executes various kinds of processing based on the data received by the communication interface 160 and the data stored in the data storage 164. The data processing device 162 also functions as an interface between the communication interface 160 and the data storage 164.

The communication interface 160 includes a transmitter 166 that transmits various kinds of data and a receiver 168 that receives data.

The data processing device 162 includes a player management unit 170 and an occupancy management unit 172. The player management unit 170 performs management related to the pairing and transfer of credits. The occupancy management unit 172 manages the occupancy of a claw crane device 104 by a player.

FIG. 4 is a functional block diagram of the claw crane device 104.

The claw crane device 104 includes a user interface processing device 180, a mechanism device 182, a data processing device 186, a communication interface 184, and a data storage 188.

The user interface processing device 180 may comprise a CPU (central processing unit) and receives operations from the player via various input devices and also handles processing related to the user interface, such as image display and audio output. The mechanism device 182 drives various mechanisms such as the crane 118 and the prize stock space 132. The communication interface 184 handles communication processing with the user terminal 110 and the relay device 108. The data storage 188 stores various kinds of data. The data processing device 186 may comprise a CPU (central processing unit) and executes various kinds of processing based on the data inputted from the user interface processing device 180, the data received by the communication interface 184, and the data stored in the data storage 188. The data processing device 186 also functions as an interface between the mechanism device 182, the user interface processing device 180, the communication interface 184, and the data storage 188.

The user interface processing device 180 includes the operation device 142 that receives input from the player and an output device 190 that outputs various kinds of information, such as images and sounds, to the player. The output device 190 includes a display device 192 that displays images on the setting display 144, etc. The player operates the operation device 142 to play the claw crane.

The communication interface 184 includes a transmitter 194 that transmits various kinds of data to the server 102, etc. and a receiver 196 that receives data.

The mechanism device 182 includes the crane driver 148 and the camera 122 (imaging device). As discussed above, the camera 122 installed on the ceiling of the claw crane device 104 captures an image of the prize placement platform 116 (game field). This captured image allows the player to ascertain the placement and movement path of a prize. Also, when a captured image is displayed on the monitor 120, it is easier for the player to accurately ascertain the positional relationship between the crane 118 and a prize. As discussed above, the movement, grasping, and release of the crane 118 are performed by the crane driver 148.

The data processing device 186 includes a game control unit 198, a credit management unit 204, a code generation unit 206, and an occupancy setting unit 208.

The game control unit 198 controls the progress of the claw crane. The game control unit 198 includes a crane controller 200 (movement controller) and a movement determination part 202. The crane controller 200 instructs the crane driver 148 to move, grasp, or release according to an operation instruction from the operation device 142. The movement determination part 202 determines whether a prize has dropped through the drop opening 130, or in other words whether the player has been successful at the claw crane. The credit management unit 204 converts into credits the play fee inserted by the player into the claw crane device 104. The code generation unit 206 generates a two-dimensional code (discussed below). The occupancy setting unit 208 sets the state of the claw crane device 104 to either an “occupied state” or a “cancelled state” according to an instruction from the player.

The data storage 188 stores instructions such as a game program for the claw crane as well as information related to the settings, game play results, and other data related to usage status.

### Pairing Function

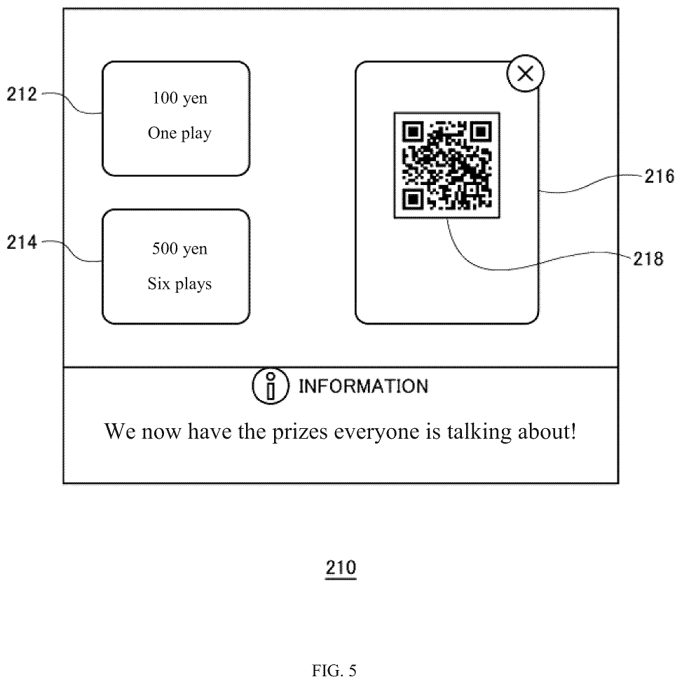

FIG. 5 is a diagram of the initial screen 210.

The display device 192 causes the setting display 144 to display the initial screen 210. The setting display 144 includes a single-play button 212, a multi-play button 214, and a pairing setting area 216. In the pairing setting area 216, a two-dimensional code 218 including the game machine ID is displayed. In one or more embodiments, the two-dimensional code 218 is described as being a QR code (registered trademark), but the two-dimensional code 218 may instead be an image in which the game machine ID has been encoded.

Before playing, the player captures an image of the two-dimensional code 218 with the camera of the user terminal 110. The CS software of the user terminal 110 extracts the game machine ID from the two-dimensional code 218 and then accesses the server 102, and the server 102 starts pairing processing (discussed below). As a result of the pairing, the server 102 registers the player ID and the game machine ID in association with each other. That is, the pairing results in the claw crane device 104 being associated with the player who is playing the claw crane on that claw crane device 104.

After the pairing is completed, the player pays a play fee. The play fee may be paid in coins or in electronic money. If the player wants to play the claw crane one time, the player touches the single-play button 212. After touching the single-play button 212, the player pays a credit unit price. In the claw crane device 104 shown in FIG. 5, the credit unit price is 100 yen. After payment, the credit management unit 204 generates one credit.

If the player wants to play the claw crane six times, the player touches the multi-play button 214. After touching the multi-play button 214, the player pays the designated amount of 500 yen. When the multi-play button 214 is touched, the credit management unit 204 generates six credits for a payment of 500 yen. Since a player can receive six credits for a play fee of five credits, it is advantageous for the player to purchase six credits at once. Each time the claw crane is played, the credit management unit 204 subtracts one credit.

The player can obtain benefits by installing the CS software on the user terminal 110, registering as a player, and performing pairing processing. For example, the player management unit 170 of the server 102 may transmit a coupon that functions as electronic money to the user terminal 110 of a player who plays the claw crane after pairing. By using this coupon, the player can receive a discount on the play fee the next time. In one or more embodiments, the occupancy function and transfer function (discussed below) will be described on the assumption that pairing processing has been performed.

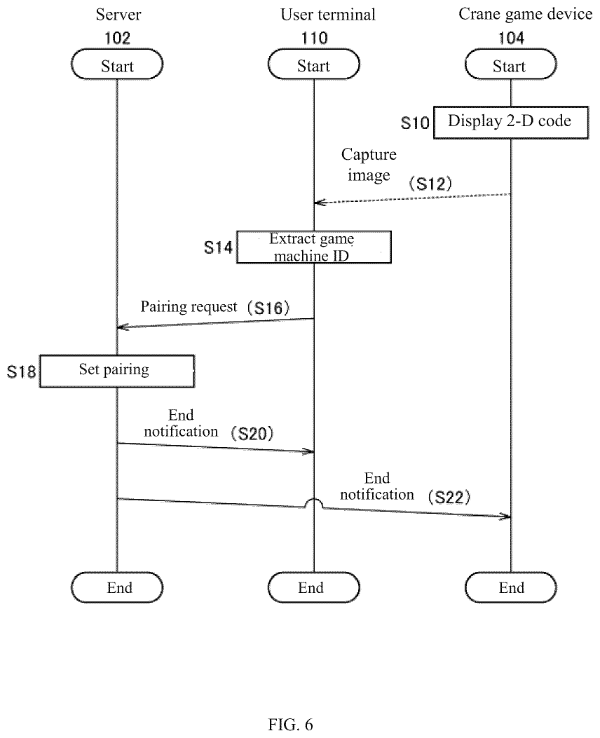

FIG. 6 is a sequence diagram showing the steps of the pairing processing.

The code generation unit 206 of the claw crane device 104 displays a two-dimensional code 218, which is an encoded version of the game machine ID, on the initial screen 210 (S10). The player captures an image of the two-dimensional code 218 with the user terminal 110 (S12). The CS software of the user terminal 110 extracts the game machine ID from the two-dimensional code 218 (S14) and transmits a pairing request to the server 102 (S16). This pairing request includes the game machine ID and the player ID.

The receiver 168 of the server 102 receives the pairing request. The player management unit 170 makes pairing settings (S18). For example, when a pairing request is transmitted from a player with a player ID of P02 (hereinafter referred to as “the player (P02)”) to the claw crane device 104 with a game machine ID of C01 (hereinafter referred to as “the claw crane device 104 (C01)”), the player management unit 170 registers C01 and P02 as a “pair” in the pairing information 220 (discussed below). This pairing allows the server 102 to ascertain the current player of the claw crane device 104 (C01).

The transmitter 166 of the server 102 notifies the user terminal 110 that the pairing is complete (S20). The transmitter 166 also notifies the claw crane device 104 that the pairing is complete (S22). When a pairing request is transmitted from a player (user terminal 110) who has already been paired, or when a pairing request is transmitted for the claw crane device 104 that has already been paired, the player management unit 170 rejects the new pairing.

Once the claw crane ends, the claw crane device 104 transmits an end notification including the game machine ID to the server 102. At this point, the player management unit 170 cancels the pairing. For example, when an end notification is transmitted from the claw crane device 104 (C01) to the server 102, the player management unit 170 cancels the pairing between the claw crane device 104 (C01) and the player (P02). The end of the claw crane may also be an explicit end instruction from the player to the claw crane device 104. When a specific amount of time has elapsed since the credits dropped to zero, the transmitter 194 of the claw crane device 104 may transmit a crane game end notification to the server 102.

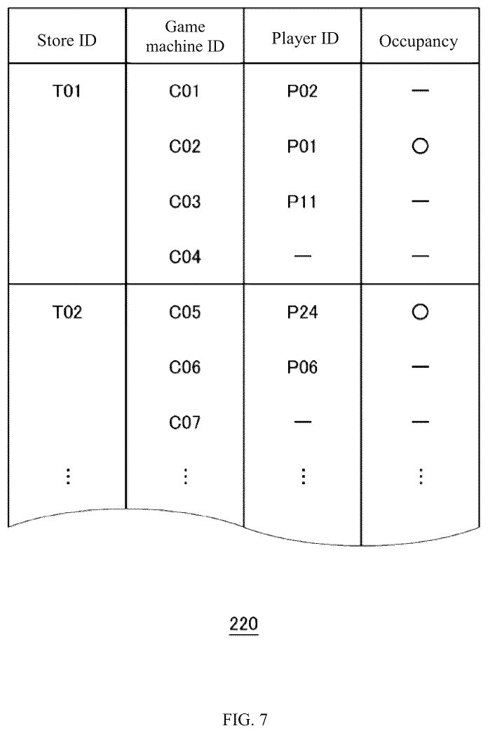

As another example, a “provisional setting” of pairing may be performed in S18 and the transmitter 166 of the server 102 may transmit a pairing confirmation to the claw crane device 104. The display device 192 of the claw crane device 104 may display a pairing confirmation screen (not shown) and, if the player has purchased credits at this time, the transmitter 194 of the claw crane device 104 may notify the server 102 of “successful pairing.” The player management unit 170 of the server 102 may confirm the pairing on condition that this notification has been received. After the pairing is confirmed, the server 102 may transmit a completion notification (S20) to the user terminal 110 and the CS software of the user terminal 110 may display a message on the screen saying “You have logged in.” In this example, the processing of S22 is unnecessary. FIG. 7 is a data structure diagram of the pairing information 220.

The pairing information 220 is stored in the data storage 164 of the server 102. The game machine ID and the store ID are associated with each other ahead of time. That is, the store in which each claw crane device 104 is installed is registered in the server 102.

Claw crane devices 104 (C01) to 104 (C04) are installed in a store (T01) having a store ID of T01. Meanwhile, a claw crane device 104 (C05) is installed in a store (T02).

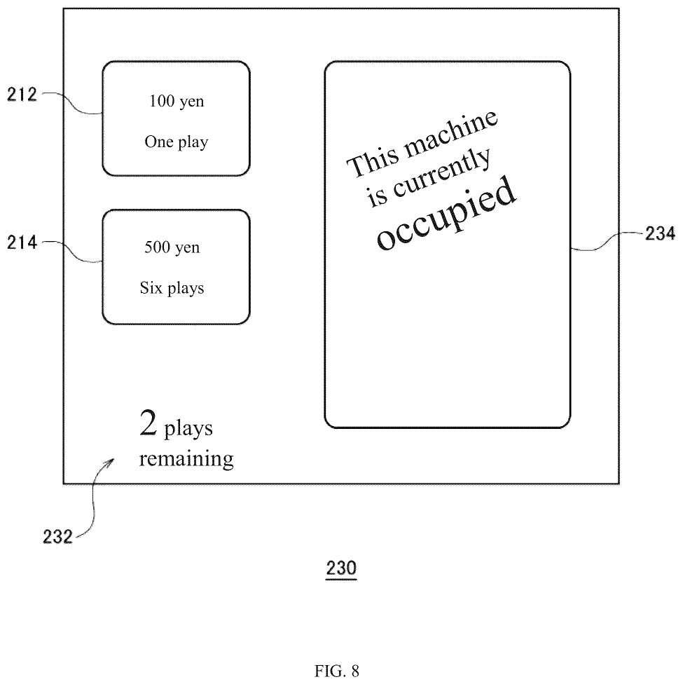

The claw crane device 104 (C01) is paired with a player (P02). The claw crane device 104 (C02) is paired with a player (P01) and is in an occupied state. Occupancy will be described in detail with reference to FIG. 8 and the subsequent drawings. The claw crane device 104 (C04) is not paired with any player and currently can be played by anyone. The player management unit 170 registers the pairing in the pairing information 220 when pairing has been established and deletes the pairing from the pairing information 220 when an end notification has been received.

### Occupancy Function

FIG. 8 is a diagram of the occupancy screen 230.

The display device 192 causes the setting display 144 to display an occupancy button (not shown). When the player touches this occupancy button, occupancy processing (discussed below) is executed and the display device 192 displays an occupancy screen 230. The occupancy screen 230 shows that the claw crane device 104 is occupied by a player (occupant). Other players cannot play the claw crane on the claw crane device 104 that is in an occupied state.

There could be a situation in which a player moves a targeted prize P with the crane 118 and is close to being able to win the prize P, but the player has to temporarily leave the claw crane device 104. For example, the player may need to exchange money to buy more credits or may need to use the restroom. In a case such as this, the claw crane device 104 is kept in an occupied state to prevent other players from using that claw crane device 104. The remaining credit area 232 indicates the number of credits that have not been used. In FIG. 8, the claw crane device 104 is in an occupied state with two credits remaining.

In another example, if there are unused credits, the display device 192 may not display the occupancy button.

The display device 192 may display the occupancy screen 230 and receive an occupancy instruction when the claw crane reaches a specific state, such as when one play is completed. In addition, the claw crane device 104 may notify the server 102 of the progress of the claw crane and the server 102 may receive an occupancy instruction on condition that the claw crane is not in the midst of being played.

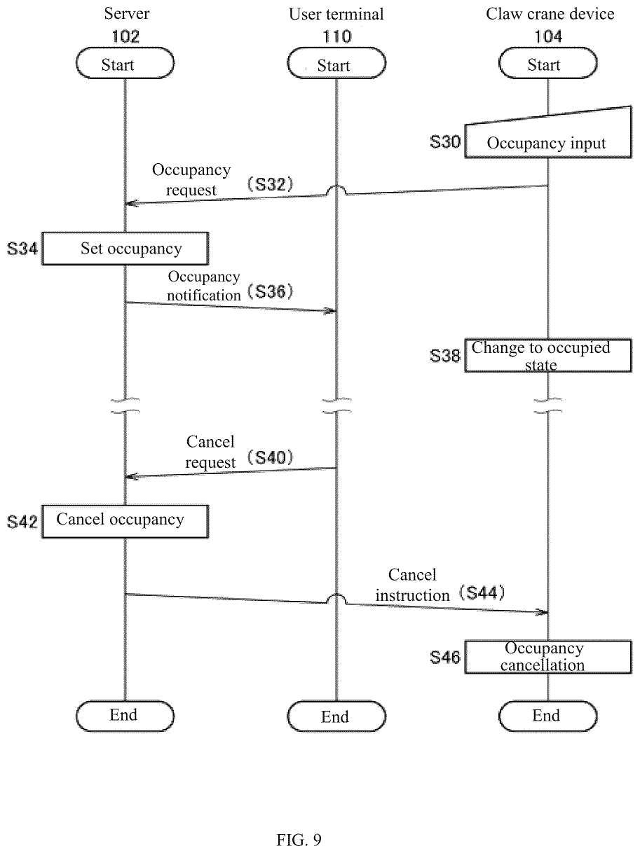

FIG. 9 is a sequence diagram showing the steps of the occupancy processing.

Here, the description will assume a case in which a player (P01) who has been paired with a claw crane device 104 (T01: C02) occupies the claw crane device 104 (C02).

The player (P01) touches the occupancy button (not shown) of the claw crane device 104 (C02) (S30). At this point, the transmitter 194 of the claw crane device 104 (C02) transmits an occupancy request including the game machine ID of C02 to the server 102 (S32).

The occupancy management unit 172 of the server 102 refers to the pairing information 220, sets the player (P01) who has been paired with the claw crane device 104 (C02) as the occupant (occupancy setting), and updates the pairing information 220 (S34). If the claw crane device 104 (C02) has not been paired, occupancy setting is not executed.

After the occupancy setting, the transmitter 166 transmits an occupancy notification to the user terminal 110 (P01) (S36). Meanwhile, after transmitting the occupancy request, the occupancy setting unit 208 of the claw crane device 104 (C02) changes the state of the claw crane device 104 from a cancelled state to an occupied state (S38). At this point, the display device 192 displays an occupancy screen 230 (see FIG. 8) indicating that the machine is occupied.

When the player (P01) wants to resume a claw crane on the claw crane device 104 (C02), they touch a cancel button (not shown) on the user terminal 110 (P01). At this point, a cancel request is transmitted from the user terminal 110 to the server 102 (S40). The cancel request includes the player ID of P01.

The occupancy management unit 172 of the server 102 refers to the pairing information 220, performs cancellation settings for the claw crane device 104 (C02) with which the player (P01) is paired, and updates the pairing information 220 (S42). If pairing has not been established for the player (P01) who transmitted the cancel request, the cancel request is not accepted.

After the cancellation setting, the transmitter 166 of the server 102 transmits a cancellation instruction (S44) to the claw crane device 104 (C02) (S44). The occupancy setting unit 208 of the claw crane device 104 (C02) changes the state of the claw crane device 104 (C02) from an occupied state to a cancelled state (S46). At this point, the display device 192 changes the occupancy notification area 234 to a non-display state.

As discussed above, the player (P01) who is paired with the claw crane device 104 (C02) can temporarily occupy the claw crane device 104 (C02). Also, only the occupant (P01) can cancel the occupancy of the claw crane device 104 (C02).

If the occupant (P01) forgets to cancel the occupancy of the claw crane device 104 (C02), the claw crane device 104 (C02) will remain unplayable, which is inconvenient for the player. In view of this, in the game system 100 of one or more embodiments, the settings are made so that the occupancy of the claw crane device 104 (C02) can be exceptionally cancelled by someone other than the occupant (P01) based on two time limits, one for a “first time” and one for a “second time.”

The first time is a time limit set in the server 102. In one or more embodiments, the first time is 180 seconds (3 minutes). After the occupancy setting (S34), the occupancy management unit 172 of the server 102 measures the elapsed time. If the first time has elapsed, the occupancy management unit 172 instructs the transmitter 166 to transmit a first cancellation instruction to the claw crane device 104 (C02).

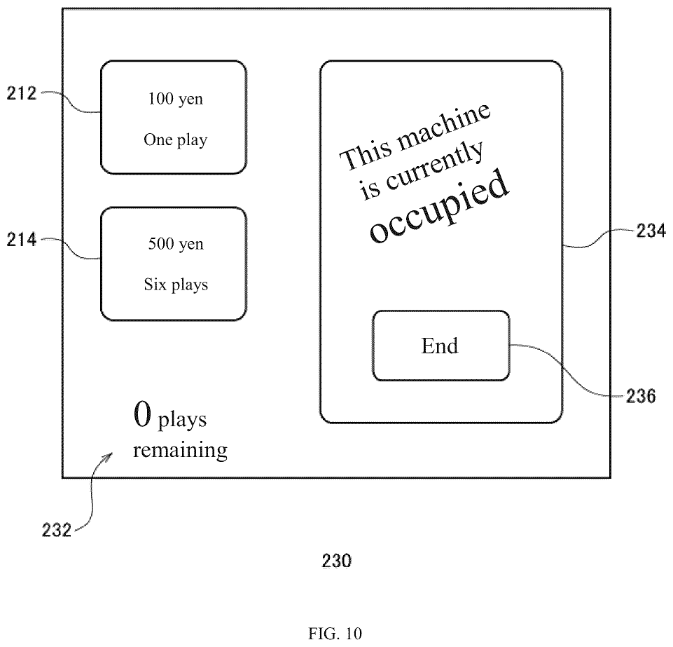

When the first cancellation instruction is received, the occupancy setting unit 208 of the claw crane device 104 (C02) displays a cancel button 236 on the occupancy screen 230 (see FIG. 10). Thereafter, when anyone, and not just the occupant (P01), touches the cancel button 236, the occupancy setting unit 208 of the claw crane device 104 (C02) changes the state from an occupied state to a cancelled state. After the occupancy is cancelled, the claw crane device 104 (C02) transmits a cancellation notification to the server 102, and the occupancy management unit 172 of the server 102 updates the pairing information 220.

Thus, even if the player (P01) forgets to cancel the occupancy, anyone can cancel the occupancy of the claw crane device 104 (C02) once the first time has elapsed. Therefore, this prevents the claw crane device 104 (C02) from being continuously and unfairly occupied.

The second time is a time set in the claw crane device 104 (C02). In one or more embodiments, the second time period is 300 seconds (5 minutes). The occupancy setting unit 208 of the claw crane device 104 (C02) measures the elapsed time after setting to the occupied state (S38). When the second time has elapsed, the occupancy setting unit 208 automatically changes the occupied state to the cancelled state. After the occupancy is cancelled, the claw crane device 104 (C02) transmits a cancellation notification to the server 102, and the occupancy management unit 172 of the server 102 updates the pairing information 220. With this control method, even if a communication failure should occur between the claw crane device 104 and the server 102, the claw crane device 104 can automatically cancel the occupancy after the second time has elapsed.

In another example, the occupancy setting unit 208 of the claw crane device 104 (C02) may display the cancel button 236 on the occupancy screen 230 when the first time has elapsed after changing to the occupied state (S38).

### Transfer Function

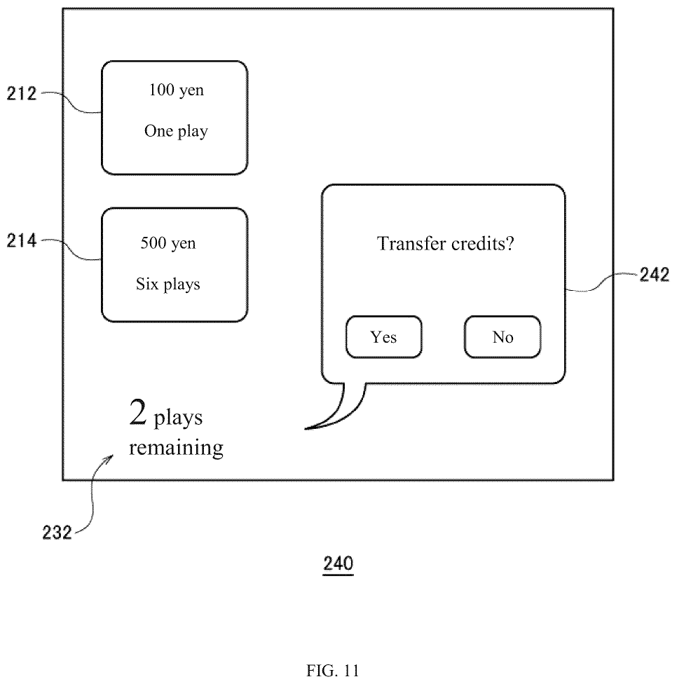

FIG. 11 is a diagram of the transfer screen 240.

If the player has successfully won a prize and still has unused credits, the display device 192 displays a transfer screen 240. The player may use these unused credits to try to win another prize, or may transfer the unused credits to another claw crane device 104.

Here, let us assume that a player (P01) who is paired with the claw crane device 104 (C02) has two credits remaining upon winning a prize. The transfer function allows the player (P01) to convert the two unused credits into credits for another claw crane device 104.

In the transfer screen 240 of FIG. 11, two credits are still unused. Let us assume that the player (P01) has touched the multi-play button 214 to purchase six credits for 500 yen, and has won a prize P upon spending four credits, that is, upon making four attempts. The player (P01) ends the claw crane since there are no more prizes P that they want to win in the claw crane device 104 (C02).

If the player (P01) wants to transfer credits, they select the “Yes” button in the transfer confirmation area 242. At this point, the two unused credits are first registered in the server 102, as will be described in detail below. Hereinafter, transferring unused credits from a claw crane device 104 (transfer source) to the server 102 shall be referred to as a “first transfer,” and transferring credits from the server 102 to another claw crane device 104 (transfer destination) shall be referred to as a “second transfer.”

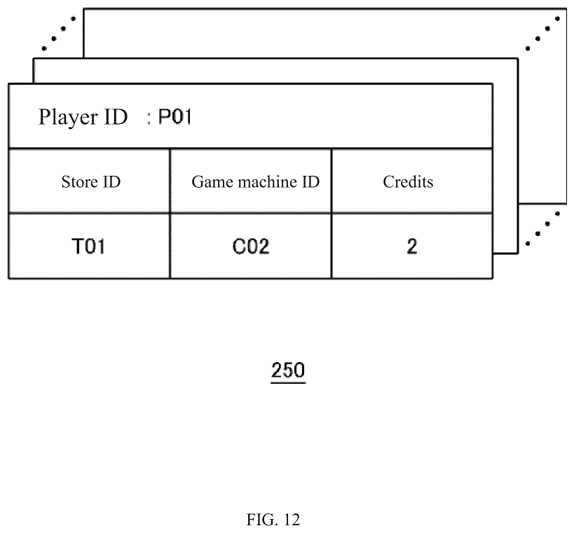

FIG. 12 is a diagram showing the data structure of the credit management information 250.

The credit management information 250 is stored in the data storage 164 of the server 102. The credit management information 250 associates the claw crane device 104 with a player and any unused credits. When the player (P01) issues an instruction to transfer the unused credits of the claw crane device 104 (C02) by the method described below, the player management unit 170 updates the credit management information 250 and performs a first transfer of the unused credits.

Let us assume that the player (P01) issues a transfer instruction for two unused credits at a claw crane device 104 (C02) in a store (T01). At this point, as shown in the credit management information 250 of FIG. 12, the store ID, the game machine ID, the player ID, and any unused credits are registered in association with each other. Two credits being displayed in the credit management information 250 indicates that the player (P01) has two unused credits remaining on the claw crane device 104 (C02). That is, the credit management information 250 indicates the credits of the first transfer.

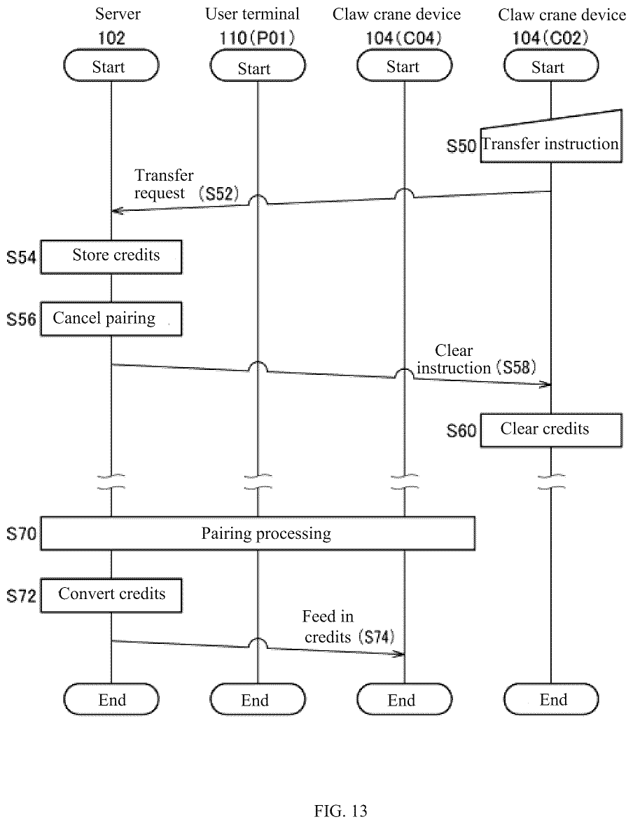

FIG. 13 is a sequence diagram showing the steps of the transfer processing.

Here, the description will assume a case in which a player (P01) who is paired with the claw crane device 104 (T01:C02) transfers unused credits from the claw crane device 104 (C02) to the claw crane device 104 (C04).

The player (P01) uses the transfer screen 240 of the claw crane device 104 (C02) to issue an instruction to transfer credits (S50). At this point, the credit management unit 204 of the claw crane device 104 (C02) instructs the transmitter 194 to transmit to the server 102 a transfer request including the number of unused credits and the game machine ID of C02 (S52). At this point, the credit management unit 204 may transmit to the server 102 a play fee corresponding to the unused credits.

The player management unit 170 identifies the player (P01) who is paired with the claw crane device 104 (C02), and registers the unused credits in the credit management information 250 (S54). The player management unit 170 cancels the pairing between the claw crane device 104 (C02) and the player (P01) (S56).

After registration of the unused credits, the transmitter 166 transmits a clear instruction to the claw crane device 104 (C02) (S58). The credit management unit 204 of the claw crane device 104 (C02) deletes the unused credits from the memory in the housing (S58). The result of the above processing is that the unused credits in the claw crane device 104 (C02) undergo a first transfer to the server 102.

Next, the steps in the second transfer will be described, in which the unused credits transferred in the first transfer to the server 102 are then transferred to the claw crane device 104 (C04).

The player (P01) is paired with the claw crane device 104 (C04) (S70). The pairing processing here is similar to the processing steps from S10 to S22 shown in FIG. 6.

The player management unit 170 converts the unused credits registered in the pairing information 220 of the claw crane device 104 (C02) into credits for the claw crane device 104 (C04) (S72). For example, let us assume that the credit unit price of the claw crane device 104 (C02) (transfer source) is 100 yen, the credit unit price of the claw crane device 104 (C04) (transfer destination) is 200 yen, and there are two unused credits in the claw crane device 104 (C02) (transfer source).

In this case, the value of the two unused credits in the transfer source claw crane device 104 (C02) is 200 yen (=100×2), which corresponds to one credit in the transfer destination claw crane device 104 (C04). Therefore, the player management unit 170 converts two credits of the claw crane device 104 (C02) into one credit of the claw crane device 104 (C04).

After this conversion, the transmitter 166 notifies the transfer destination claw crane device 104 (C04) of the number of credits (S74). The credit management unit 204 of the claw crane device 104 (C04) then grants or gives the credit to the player (P01). In the above example, the two unused credits in the claw crane device 104 (C02) become one credit in the claw crane device 104 (C04), and the player can play the claw crane one time in the claw crane device 104 (C04) without paying an additional play fee.

When the player (P01) is paired with the claw crane device 104 (C04), the player management unit 170 may automatically execute the conversion of credits and the second transfer that goes along with this. In the above example, when pairing with the claw crane device 104 (C04) has been established, one credit is automatically fed into the claw crane device 104 (C04). In addition, before the second transfer, the claw crane device 104 (C04) may display a confirmation screen (not shown) for confirming the number of credits. The second transfer may be executed on condition that the player (P01) has issued an instruction for a second transfer of credits on this confirmation screen.

The credit conversion may also be executed by the transfer destination claw crane device 104 (CY), rather than by the server 102. For example, let us assume that the fee corresponding to the unused credits in the transfer source claw crane device 104 (CX) is 500 yen. The server 102 divides this 500 yen by 100 (the unit fee) to convert it into five points. Let us assume that one credit in the transfer destination claw crane device 104 (CY) is 200 yen (two points). The server 102 notifies that five points are available at the time of pairing. The credit management unit 204 of the claw crane device 104 (CY) may divide these five points by two points (worth 200 yen), and process the resulting two credits as credits that can be used by the player.

### SUMMARY

The game system 100 was described above based on the embodiments.

With one or more embodiments, a player can transfer remaining credits from one claw crane device 104 to another claw crane device 104. Even after a prize P has been won, the credits will not go to waste, so the player can buy credits in bulk without worry.

The player performs pairing processing before playing the claw crane. The player can easily perform the pairing processing simply by capturing an image of the two-dimensional code 218 with the user terminal 110. If the player has been paired, the player can transfer credits with a simple operation, without having to input a player ID, a game machine ID, the number of credits, and so forth.

Also, the player can occupy the claw crane device 104 by touching an occupancy button (not shown) on the claw crane device 104. Therefore, even if a player should have to temporarily leave the claw crane device 104 just before winning a prize, that player can prevent the prize from being taken by another player.

Even though the claw crane device 104 can be occupied by touching the occupancy button, if the device is designed so that anyone can cancel the occupancy, the interests of the occupant cannot be protected. In one or more embodiments, the claw crane device 104 is designed such that only the occupant can cancel the occupancy, which ensures the occupancy of the claw crane device 104. Also, since the occupant is paired, the occupant can occupy the claw crane device 104 with a simple operation by merely touching the occupancy button, without having to input a player ID or the like.

Furthermore, the claw crane device 104 can be prevented from being occupied for a long period of time by setting the first and second times, which is beneficial in terms of both occupancy and maintaining customer turnover.

The present invention is not limited to the above embodiments and modification examples, and the constituent elements can be modified and embodied without departing from the gist of the present invention. Various inventions may be formed by appropriately combining a plurality of the constituent elements disclosed in the above embodiments and modification examples. Also, some of the constituent elements shown in the above embodiments and modification examples may be omitted.

### MODIFICATION EXAMPLES

In the above embodiments, it was described that the player performs pairing processing with the claw crane device 104 and then plays the claw crane. In a modification example, the claw crane can be played without performing the pairing processing.

The CS software of the user terminal 110 may cause a two-dimensional code encoding the player ID to be displayed on the screen of the user terminal 110. This two-dimensional code is captured by a camera built into the claw crane device 104. Then, the claw crane device 104, rather than the user terminal 110, may transmit to the server 102 a pairing request including the game machine ID and the player ID.

The player may also manually input the game machine ID of the claw crane device 104 into the user terminal 110. Alternatively, the player may manually input the player ID into the claw crane device 104. Here again, the user terminal 110 or the claw crane device 104 may transmit a pairing request including the game machine ID and the player ID to the server 102.

In the above embodiments, it was described that the player performs occupancy input on the screen of the claw crane device 104. In a modification example, the player may perform occupancy input on the screen of the user terminal 110. At this point, the user terminal 110 may transmit an occupancy request including the player ID to the server 102, and the server 102 may set occupancy for the claw crane device 104 that is paired with that player ID.

In the above embodiments, it was described that the player issues a transfer instruction on the screen of the claw crane device 104. In a modification example, the player may issue the transfer instruction on the screen of the user terminal 110. In that case, the user terminal 110 may transmit a transfer request including the player ID to the server 102, and the server 102 may execute transfer processing for the claw crane device 104 that is paired with that player ID.

The player may also extend the first time, which is the time limit for occupancy. For example, the player (P01) occupying the claw crane device 104 (C02) may transmit an extension request to the server 102 from the user terminal 110 (P01). This extension request includes the player ID. At this point, if the claw crane device 104 (C02) paired with the player (P01) is already occupied, the occupancy management unit 172 of the server 102 adds a specific extension time to the first time.

The extension request may be limited to a specific number of times, such as once. Also, the right to request an extension may be granted only to specific players who are pre-registered. The player management unit 170 may approve the extension of the first time on condition that an extension fee has been paid by the player. More specifically, when a player (P01) transmits an extension request to the server 102, the player management unit 170 may extend the first time after debiting the extension fee from a bank account that has been associated with the player (P01).

The player management unit 170 may set a time limit on the storage period for unused credits from the first transfer to the server 102. For example, the player management unit 170 may delete any credits registered in the credit management information 250 at a specific time, such as at 5:00 p.m. every day. Alternatively, the player management unit 170 may delete any unused credits for which a transfer instruction was issued by the player at a specific time, such as one hour, after the transfer instruction. With a control method such as this, unused credits will not be saved in the server 102 indefinitely, which encourages the player to play another claw crane.

The player management unit 170 may limit the claw crane devices 104 to which unused credits can be transferred to those within the same store. More specifically, the player management unit 170 may permit a second transfer of unused credits in a claw crane device 104 (C01) in a store (T01) to a claw crane device 104 (C02) in the same store, but may not permit a second transfer to a claw crane device 104 (C06) in a different store (T02). With a control method such as this, credits purchased at one store (T01) can be prevented from being taken to another store, so the store (T02) can avoid the disadvantage of a claw crane being played using credits from another store which were not bought on their premises.

In converting unused credits, the player management unit 170 may determine whether a second transfer is possible based on the credit unit price in the claw crane device 104 that is the transfer source and the credit unit price in the claw crane device 104 that is the transfer destination. For example, let us assume that the credit unit price of the claw crane device 104 (C10) is 100 yen and the credit unit price of the claw crane device 104 (C11) is 150 yen. Let us also assume that the player (P20) has 2 remaining credits in the claw crane device 104 (C10). In this case, the value of the two unused credits is 100×2, or 200 yen. The credit unit price of the claw crane device 104 (C11) that serves as a transfer destination is 150 yen, which is not divisible by 200 yen. When the play fee corresponding to the unused credits of the transfer source is thus not divisible by the credit unit price of the transfer destination, the player management unit 170 may not permit the second transfer of credits.

The player management unit 170 may recognize the credits of the transfer source claw crane device 104 as those of the transfer destination claw crane device 104 regardless of the conversion rate of the credit unit price. For example, even if the credit unit prices of the claw crane device 104 (C10) and the claw crane device 104 (C12) are different, the player management unit 170 may go ahead and convert the two unused credits remaining in the claw crane device 104 (C10) into two credits for the claw crane device 104 (C12). Even if a player has a large number of unused credits remaining in the claw crane device 104 (C10), the player can use the same number of credits in the claw crane device 104 (C12), making it easier for the player to buy credits in bulk.

The player management unit 170 may calculate the number of credits for the transfer destination based on the conversion rate between the credit unit price of the transfer source claw crane device 104 and the credit unit price of the transfer destination claw crane device 104. For example, let us assume that the credit unit price of the transfer source claw crane device 104 (C10) is 100 yen, and the credit unit price of the transfer destination claw crane device 104 (C13) is 150 yen. Also, let us assume that the number of unused credits on the claw crane device 104 (C10) is two. In this case, since the value of the two unused credits is 200 yen, one credit (=200-150) may be given to the transfer destination. On the other hand, if the credit unit price of the transfer destination is 60 yen, the player management unit 170 may give three credits (=200-60) to the transfer destination.

In the above embodiments, it was described that the display device 192 displays the transfer screen 240 when a prize is won. In a modification example, the display device 192 may display the transfer screen 240 on the setting display 144, either at some particular point or all the time.

In the transfer function of the above embodiments, it was described that the unused credits of one claw crane device 104 are first subjected to a first transfer to the server 102, and that the credits that have undergone this first transfer to the server 102 are then subjected to a second transfer to another claw crane device 104. The unused credits may be set to be available for use on gaming devices other than the claw crane device 104. For example, the unused credits of one claw crane device 104 may be converted into credits of another commercial game machine other than a claw crane device 104, such as a racing game machine. Alternatively, the unused credits may be available for redemption for other items of value provided by the store, such as food and beverages.

In the above embodiments, it was described that the occupancy function can be used on the premise that pairing processing is performed. In a modification example, even an unpaired player may occupy the claw crane device 104. More specifically, the player inputs a player ID during the occupancy input, and the claw crane device 104 transmits an occupancy request including the player ID and the game machine ID to the server 102. At this point, the server 102 sets the claw crane device 104 to an occupied state. Also, the player may cancel the occupancy by inputting their player ID into the claw crane device 104 when cancelling the occupancy.

Similarly, even an unpaired player may be allowed to use the transfer function. The player inputs a first transfer instruction along with the player ID during transfer. At this point, the claw crane device 104 transmits a transfer instruction to the server 102. The server 102 registers the player ID, the game machine ID, and the number of credits in the credit management information 250 in association with each other.

Next, the player inputs a second transfer instruction for credits on the claw crane device 104 that serves as a transfer destination. At this point, the player inputs their player ID. The claw crane device 104 transmits a credit acquisition request including the player ID to the server 102. The server 102 then gives the credits associated with this player ID to the transfer destination claw crane device 104.

The pairing function, occupancy function, and transfer function can be applied to applications other than claw cranes. For example, the pairing function and the occupancy function may be realized in a commercial game machine for a racing game or the like. Also, unused credits in a commercial video game machine such as a racing game may be made available for use as credits in amusement machines other than video games, such as in a photo booth machine.

### Addenda

The following inventions will be apparent from the above descriptions of the embodiments and modification examples. A1. A game system comprising a game device, a communication terminal, and a server,
wherein a game machine ID for identifying the game device is registered in the game device, and a player ID for identifying the player is registered in the communication terminal, and either the game device or the communication terminal acquires an ID registered in the other device and transmits the ID registered in itself and the ID acquired from the other device to the server, and
the server includes
a player management unit that associates the transmitted player ID and game machine ID and registers these as a pair, and
an occupancy management unit that sets a first game device to be unavailable when an occupancy instruction has been received from a player, and
the occupancy management unit sets the first game device to be available when a cancellation instruction has been received from the player who is registered as a pair with the first game device.

A2. The game system according to A1, wherein the occupancy management unit receives an occupancy instruction from the player on condition that the game in the first game device has reached a specific state.

A3. The game system according to A1 or A2, wherein the occupancy management unit displays a cancellation screen on the first game device when a first time has elapsed since the first game device was set to be unavailable, and the first game device is set to be available when any player has issued an instruction to cancel the occupancy on the cancellation screen.

A4. The game system according to any of A1 to A3, wherein the first game device is set to be available when a second time has elapsed since the first game device was set to be unavailable.

A5. The game system according to A3, wherein the occupancy management unit of the server extends the first time when an extension instruction has been received from a player who is registered as a pair with the first game device in a state in which the first game device is set to be unavailable.

A6. The game system according to A5, wherein the occupancy management unit of the server receives the occupancy instruction and/or the extension instruction on condition that a fee has been paid by the player.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

100 game system, 102 server, 104 claw crane device, 106 Internet, 108 relay device, 110 user terminal, 112 base, 114 prize holder, 116 prize placement platform, 118 crane, 120 monitors, 122 camera, 124 door, 126 first area, 128 second area, 130 drop opening, 132 prize stock space, 134 prize removal opening, 136 control console, 138 coin slot, 140 IC card reader, 142 operation device, 142a operation button, 142b operation button, 144 setting display, 146 arms, 148 crane driver, 150 post, 160 communication interface, 162 data processing device, 164 data storage, 166 transmitter, 168 receiver, 170 player management unit, 172 occupancy management unit, 180 user interface processing device, 182 mechanism device, 184 communication interface, 186 data processing device, 188 data storage, 190 output device, 192 display device, 194 transmitter, 196 receiver, 198 game control unit, 200 crane controller, 202 movement determination part, 204 credit management unit, 206 code generation unit, 208 occupancy setting unit, 210 initial screen, 212 single-play button, 214 multi-play button, 216 pairing setting area, 218 2-D code, 220 pairing information, 230 occupancy screen, 232 remaining credit area, 234 occupancy notification area, 236 cancel button, 240 transfer screen, 242 transfer confirmation area, 250 credit management information

What is claimed is:

1. A game system comprising:
a plurality of item acquisition game devices; and
a server, wherein
each of the item acquisition game devices comprises:
a game field that is disposed in a play space and has a first area and a second area, wherein items to be acquired are placed in the first area and moved to the second area;
an item holder that holds one or more of the items;
an operation device that receives operations from a player; and
a data processing device that:
gives credits depending on a play fee paid by the player,
drives the item holder in response to the operations on condition that credits have been used, and
determines whether one or more of the items have been successfully moved to the second area,
the item acquisition game devices include a first item acquisition game device, and a second item acquisition game device that serves as a transfer destination, and
the server comprises:
a data processing device that converts credits that are unused in the first item acquisition game device into credits for the second item acquisition game device, after receiving a transfer instruction for credits given in the first item acquisition game device from the player.

2. The game system according to claim 1, wherein
the data processing device of each of the item acquisition game devices further:
generates a two-dimensional code by encoding a game machine ID of each of the item acquisition game devices,
upon capturing an image of the two-dimensional code, the communication terminal transmits a player ID and the game machine ID to the server, and
the data processing device of the server registers, as a pair, the player ID and the game machine ID to be associated with each other.

3. The game system according to claim 2, wherein
the data processing device of the server receives the transfer instruction on condition that the player is registered as a pair with the first item acquisition game device.

4. The game system according to claim 1, wherein
the data processing device of the server sets a time limit on a storage period for the credits that are unused for which the transfer instruction has been issued.

5. The game system according to claim 1, wherein
the data processing device of the server converts the credits that are unused into the credits for the second item acquisition game device on condition that the second item acquisition game device is installed in a store same as a store in which the first item acquisition game device is installed.

6. The game system according to claim 1, wherein
the data processing device of the server calculates the number of converted credits in the second item acquisition game device based on a play fee corresponding to the credits that are unused and a unit price of the credits in the second item acquisition game device.

7. The game system according to claim 1, wherein
each of the item acquisition game devices further comprises:
a display device that displays a transfer screen once one or more of the items are successfully transferred to the second area, and
the data processing device of the server receives the transfer instruction on the transfer screen of the first item acquisition game device.

8. An item acquisition game device, comprising:
a game field that is disposed in a play space and has a first area and a second area, wherein items to be acquired are placed in the first area and moved to the second area;
an item holder that holds one or more of the items;
an operation device that receives operations from a player;
a data processing device that:
gives credits depending on a play fee paid by the player;
drives the item holder in response to the operations on condition that credits have been used; and
determines whether one or more of the items have been successfully moved to the second area, wherein
the data processing device outputs, to an external device, information on at least one of unused credits and the play fee corresponding to the unused credits, in response to a credit transfer instruction received from the player.

9. A game system comprising:
a plurality of game devices;
a communication terminal; and
a server, wherein
a game machine ID for identifying each of the game devices is registered in each of the game devices, and a player ID for identifying the player is registered in the communication terminal,
each of the game devices comprises:
a data processing device that:
gives credits depending on a play fee paid by a player, and
controls a game progress on condition that credits have been used,
a first device that is either the game devices or the communication terminal acquires the player ID or the game machine ID registered in a second device that is either the communication terminal or the game devices, and transmits, to the server, the game machine ID or the player ID registered in the first device and the player ID or the game machine ID acquired from the second device,
the game devices include a first game device and a second game device, and
the server comprises:
a data processing device that:
registers, as a pair, the player ID and the game machine ID to be associated with each other, and
converts credits that are unused in the first game device into credits for the second game device in response to a transfer instruction for the credits that are unused received from a player registered as a pair with the first game device.
